(19) United States
(12) Patent Application Publication
(10) Pub. No.: US 2026/0347166 A1
(43) Pub. Date: Nov. 5, 2026

(54) WELL-SEALED WATER DISPENSER

(71) Applicant: Ningbo eastpure environmental technology co., Ltd, Cixi (CN)

(72) Inventor: Yanfeng Xu, Anji County (CN)

(21) Appl. No.: 19/223,025

(22) Filed: May 30, 2025

(30) Foreign Application Priority Data
Apr. 30, 2025 (CN) 202520845593.5

(51) Int. Cl. B67D 1/08; B67D 1/04; B67D 1/12

(52) U.S. Cl. CPC B67D 1/0804; B67D 1/0425; B67D 1/125; B67D 2001/0822; B67D 2210/0001

(57) ABSTRACT

Provided is a well-sealed water dispenser. A bracket is mounted at an upper opening of an outer housing. A clamping groove and a limiting groove that are spaced apart are formed in an outer side of a mounting wall edge formed by extending an inner wall of the bracket upward, providing accurate positioning and supporting to mount a main cover and a protective cover. A clamping member on an inner wall of the protective cover is snap-fitted with the clamping groove in the bracket to form a first stable and sealed barrier. A sealed tank is fixed in the outer housing, and the main cover at an opening of the sealed tank is tightly connected to a through hole in a center of the protective cover through a thread. A limiting frame provides an extra supporting point for the main cover.

### TECHNICAL FIELD

The present disclosure relates to the technical field of water dispenser devices, and in particular to a well-sealed water dispenser.

### BACKGROUND

Conventional water dispensers are typically designed in a split structure, with a sealing assembly composed of an outer cover and a sealing ring through a simple fit. They have the following technical defects: Firstly, the outer cover is only locked to the machine body in a single stage through a thread or a fastener, and is prone to seal failure when repeatedly opened and closed or vibrated in transportation, resulting in leakage of the internal water storage tank or entry of the outside pollutants. Secondly, the sealed tank and the supporting structure are not positioned constrictively therebetween, leading to an assembly clearance for stress deformation in long-term use. Thirdly, the protective cover is connected to the machine body simply, and cannot be limited in multiple stages, such that it may be opened accidentally to cause secondary pollution. For the prior art, although the double-layer protective cover is designed, the snap-fit structure has a fit clearance, and an anti-rotation limiting mechanism is not provided. Besides, a sealing device locked by a thread is used. At high temperatures, the thread fit becomes loose for expansion and contraction of a plastic component. Thus, it is desired to provide a sealing structure with a multi-seal barrier, a stable structure and ease of maintenance for the water dispenser, to solve the above technical problems. Therefore, the prior art has yet to be improved.

### SUMMARY

In view of defects of the prior art, an objective of the present disclosure is to provide a well-sealed water dispenser, to solve the problem of poor sealing performance of the prior art.

In order to achieve the above objective, the present disclosure adopts the following technical solutions: A well-sealed water dispenser includes an outer housing, where a bracket is fixed at an upper opening of the outer housing through a bolt, an inner wall of the bracket extends upward to form a mounting wall edge, and a clamping groove and a limiting groove that are spaced apart are formed in the mounting wall edge; a protective cover provided with a clamping member snap-fitted with the clamping groove; a sealed tank fixed in the outer housing, where a through hole is formed in a center of the protective cover, and a main cover threadedly connected to an opening of the sealed tank is provided at the through hole; and a limiting frame clamped between the bracket and the sealed tank, where a peripheral bump interlocked with the limiting groove is provided on a sidewall of the limiting frame.

In an embodiment of the present disclosure, a pressurizing hand pump and a relief valve are provided on the main cover; the pressurizing hand pump includes a pressurizing cylinder with a one-way valve; a bottom cover is snap-fitted to a bottom gas outlet of the pressurizing cylinder;
and the bottom cover is internally provided with a gas guide channel and connected to a bottom end of a gas guide tube through the gas guide channel.

In an embodiment of the present disclosure, a top end of the gas guide tube extends above a liquid level in the sealed tank; and a tube body of the gas guide tube is fixed by a hoop on an outer wall of a piston.

In an embodiment of the present disclosure, a stepped valve seat is provided in a bottom chamber of the pressurizing cylinder; the one-way valve is pressed into the valve seat through an interference fit; and a gas outlet is formed in a bottom of the valve seat.

In an embodiment of the present disclosure, an L-shaped clamping seat is provided at an edge of the bottom cover; a T-shaped clamping jaw is correspondingly provided at a bottom of the pressurizing cylinder; and the L-shaped clamping seat is rotatably snap-fitted with the T-shaped clamping jaw.

In an embodiment of the present disclosure, the relief valve includes a cylindrical valve body and a stepped valve core; the cylindrical valve body includes a bottom provided with a gas inlet communicating with the sealed tank, and a top provided with an adjusting threaded hole; and the stepped valve core is slidably provided in the cylindrical valve body.

In an embodiment of the present disclosure, a bottom of the sealed tank communicates with a water distribution tube; the water distribution tube is connected to a filter cartridge; and a water outlet of the filter cartridge communicates with a water dispensing spout of the water dispenser through a water collecting tube.

In an embodiment of the present disclosure, an insertion port for mounting the filter cartridge is formed in a sidewall of the outer housing; and a detachable covering plate is provided at the insertion port.

In an embodiment of the present disclosure, a depth of the clamping groove in the mounting wall edge is ⅓-½ of a thickness of the mounting wall edge; and a sealing rubber strip is provided at a bottom of the clamping groove.

In an embodiment of the present disclosure, a portion of the main cover threadedly connected to the sealed tank is provided with a sealing structure.

As mentioned above, the well-sealed water dispenser provided by the present disclosure has the following beneficial effects: The bracket is mounted at the upper opening of the outer housing, and connected stably by the bolt. The clamping groove and the limiting groove that are spaced apart are formed in an outer side of the mounting wall edge formed by extending the inner wall of the bracket upward, providing accurate positioning and supporting to mount the main cover and the protective cover. The clamping member on the inner wall of the protective cover is snap-fitted with the clamping groove in the bracket to form a first stable and sealed barrier, effectively preventing entry of outside dust and impurities. Meanwhile, the sealed tank is fixed in the outer housing, and the main cover at the opening of the sealed tank is tightly connected to the through hole in the center of the protective cover through the thread, further enhancing airtightness of the overall structure. The limiting frame is clamped between the bracket and the sealed tank, and the peripheral bump on the sidewall of the limiting frame is accurately interlocked with the limiting groove. This not only provides an extra supporting point for the main cover, but also ensures that the sealed tank is stably mounted and used without looseness or displacement. With this design, all components cooperate with each other and restrict with each other to form the whole water dispenser with excellent sealing performance. Regardless of slight vibration in daily use, or various environmental changes in long-term use, the present disclosure can keep the desirable sealing effect to effectively ensure safety and health of drinking water, offering more healthy and reliable drinking water for the user.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic structural view of a well-sealed water dispenser according to the present disclosure;

FIG. 2 is a front view of a well-sealed water dispenser according to the present disclosure;

FIG. 3 is a sectional view along A-A shown in FIG. 2;

FIG. 4 is a rear view of a well-sealed water dispenser according to the present disclosure;

FIG. 5 is a partially schematic structural view of a well-sealed water dispenser according to the present disclosure;

FIG. 6 is a schematic structural view of a bracket of a well-sealed water dispenser according to the present disclosure;

FIG. 7 is a schematic structural view of a pressurizing hand pump of a well-sealed water dispenser according to the present disclosure;

FIG. 8 is a sectional view along B-B shown in FIG. 7;

FIG. 9 is a schematic structural view of a relief valve of a well-sealed water dispenser according to the present disclosure; and

FIG. 10 is a sectional view of a relief valve of a well-sealed water dispenser according to the present disclosure.

### REFERENCE NUMERALS

1: outer housing, 11: insertion port, 2: bracket, 21: mounting wall edge, 22: clamping groove, 23: limiting groove, 3: protective cover, 31: clamping member, 4: sealed tank, 41: water distribution tube, 42: filter cartridge, 5: main cover, 6: limiting frame, 61: bump, 7: pressurizing hand pump, 71: one-way valve, 72: pressurizing cylinder, 8: relief valve, 81: cylindrical valve body, 82: stepped valve core, 9: bottom cover, and 10: gas guide tube.

### DETAILED DESCRIPTION OF THE EMBODIMENTS

The present disclosure provides a well-sealed water dispenser. To make the objectives, technical solutions, and effects of the present disclosure clearer, the following describes the present disclosure in more detail with reference to accompanying drawings and embodiments.

In the description of the present disclosure, it should be understood that orientation or position relationships indicated by terms such as ‘upper’, ‘lower’, ‘left’, and ‘right’ are orientation or position relationships as shown in the drawings. These terms are merely intended to facilitate and simplify the description of the present disclosure, rather than to limit the present disclosure. Besides, the terms such as ‘mount’ and ‘connected’ shall be understood in a broad sense. A person of ordinary skill in the art may understand specific meanings of such terms in the present disclosure based on a specific situation.

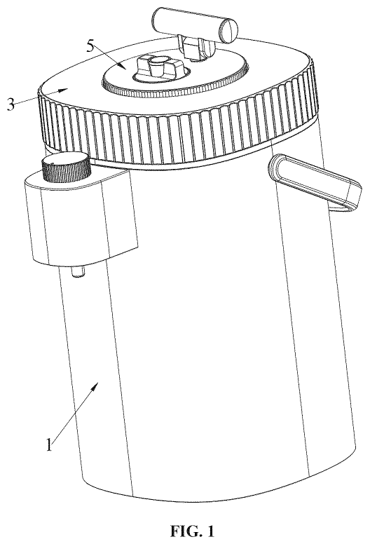

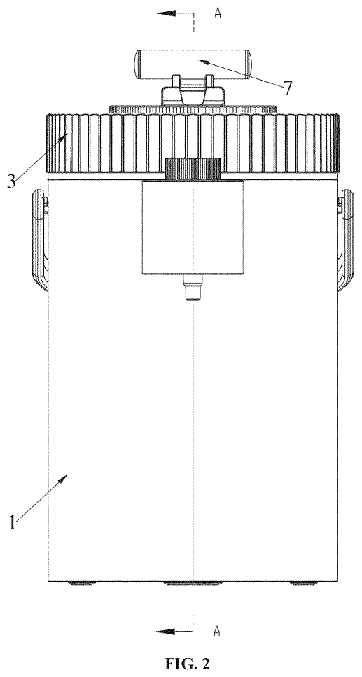

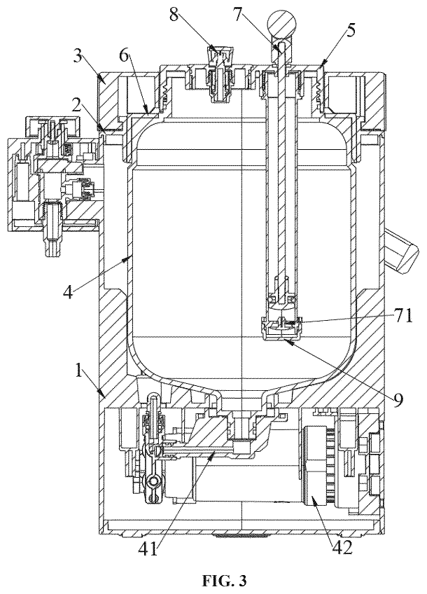

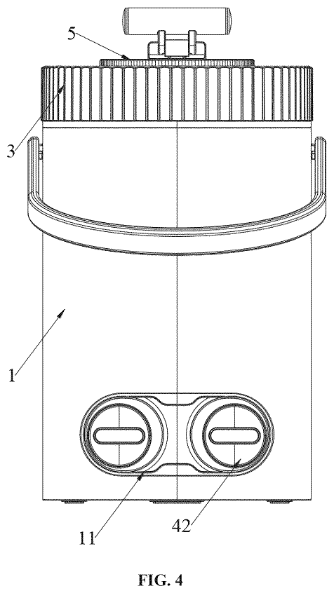

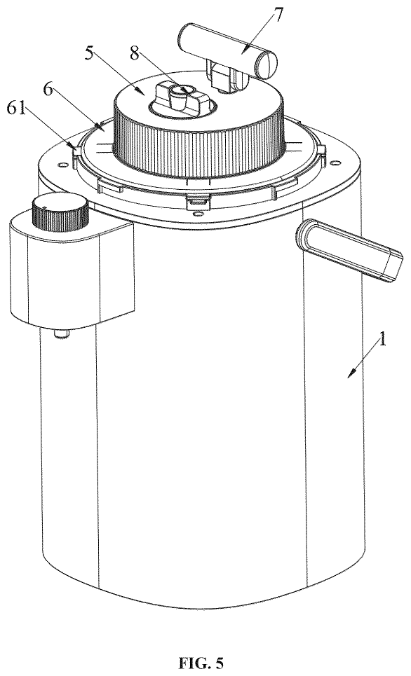

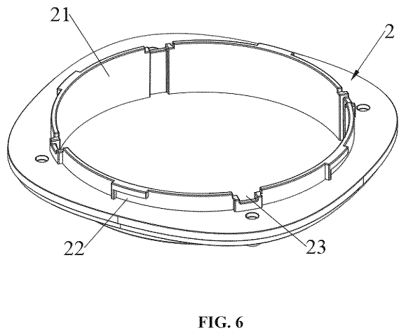

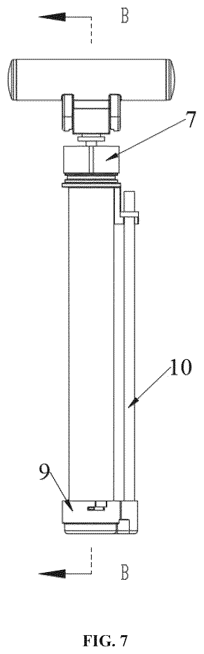

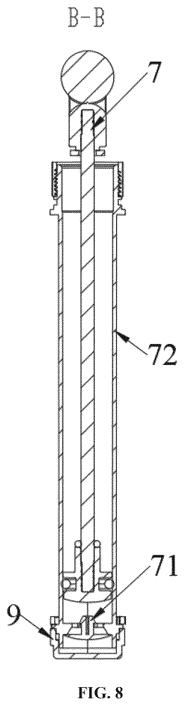

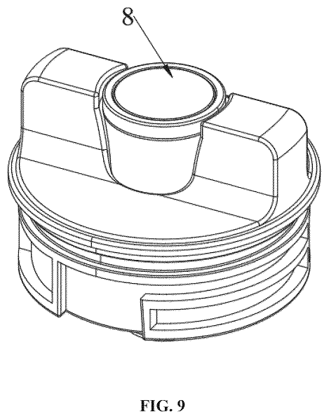

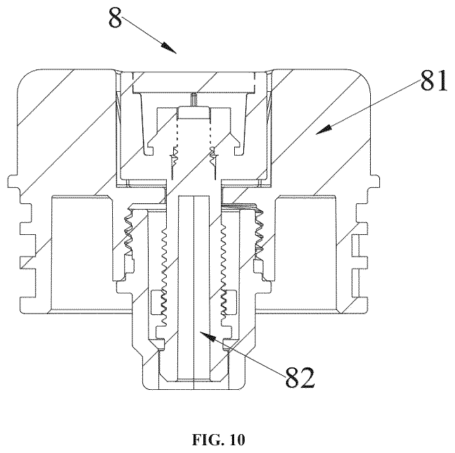

Referring to FIG. 1 to FIG. 10, the well-sealed water dispenser provided by the present disclosure includes an outer housing 1, a protective cover, a sealed tank, and a limiting frame. A bracket 2 is fixed at an upper opening of the outer housing 1 through a bolt. An inner wall of the bracket 2 extends upward to form a mounting wall edge 21. A clamping groove 22 and a limiting groove 23 that are spaced apart are formed in the mounting wall edge 21. The protective cover 3 is provided with a clamping member 31 snap-fitted with the clamping groove 22. The sealed tank 4 is fixed in the outer housing 1. A through hole is formed in a center of the protective cover 3. A main cover 5 threadedly connected to an opening of the sealed tank 4 is provided at the through hole. The limiting frame 6 is clamped between the bracket 2 and the sealed tank 4. A peripheral bump 61 interlocked with the limiting groove 23 is provided on a sidewall of the limiting frame 6.

Through radial locking formed between the clamping groove 22 of the bracket 2 and the clamping member 31 of the protective cover 3, and axial pressing in threaded connection of the main cover 5, a dual sealing structure is established. The peripheral bump 61 of the limiting frame 6 is interlocked with the limiting groove 23, preventing rotation and displacement of the sealed tank 4. With multi-directional constraints, an assembly clearance is reduced, improving overall impact and vibration resistance.

A pressurizing hand pump 7 and a relief valve 8 are provided on the main cover 5. The pressurizing hand pump 7 includes a pressurizing cylinder 72 with a one-way valve 71. A bottom cover 9 is snap-fitted to a bottom gas outlet of the pressurizing cylinder 72. The bottom cover 9 is internally provided with a gas guide channel and connected to a bottom end of a gas guide tube 10 through the gas guide channel. The pressurizing hand pump 7 injects air to the sealed tank 4 through the one-way valve 71 for pressurization, increasing a water ejection force. The relief valve 8 can adjust a pressure in the tank actively to prevent the overpressure. With a snap-fit between the bottom cover 9 and the pressurizing cylinder 72, the gas guide tube 10 is mounted quickly, and the airtightness of a gas circuit is ensured, thereby forming a pressure-controllable closed system.

A top end of the gas guide tube 10 extends above a liquid level in the sealed tank 4. A tube body of the gas guide tube 10 is fixed by a hoop on an outer wall of a piston. The gas guide tube 10 extends above the liquid level to prevent backflow of liquid to a pressurization mechanism. With the hoop for fixing the tube body, the gas circuit is not leaked for shaking, ensuring stable directional delivery of gas in pressurization. When an outlet is located above the liquid level, a pressure of the gas is controlled more easily and directly. Since the gas does not directly contact the liquid, the pressure of the gas can be controlled accurately by adjusting a gas source or the relief valve. This is applicable to occasions where the pressure is to be controlled accurately. When the gas enters the liquid from the outlet above the liquid level, bubbles are not formed on a surface of the liquid. These bubbles may affect the flowing property of the liquid, or even cause overflow of the liquid in some cases. Therefore, the bubbles are unnecessarily considered for the water dispenser in the embodiment. Since the outlet is located above the liquid level, maintenance and overhaul are realized more easily. The operator can conveniently check whether the outlet is obstructed or damaged, and make necessary maintenance. Compared with the outlet located in the liquid, the outlet above the liquid level is less risky to cause leakage or other faults. Since the gas is not directly mixed with the liquid, the explosion or pollution risk is reduced.

A precise assembly structure is employed by a stepped valve seat and the one-way valve 71 of the pressurizing cylinder 72. A progressive interference fit is formed between a multi-stage stepped necking on an inner wall of the valve seat and an outer edge of the one-way valve 71, ensuring that the one-way valve 71 is still axially sealed when impacted by a high-pressure gas to effectively prevent backflow of the gas. A gas outlet formed annularly in a bottom of the valve seat realizes a dynamic balance between the bottom chamber and the outside pressure in reciprocating motion of a piston, eliminating adsorption resistance for a pressure difference between the inside and the outside of the chamber when the piston moves down, and ensuring that the hand pump is operated more smoothly. Meanwhile, due to a gas flow buffering action of the gas outlet, turbulence-induced whistling noise in high-speed motion of the piston can be reduced, significantly improving use experience.

A rotary snap-fit locking mechanism is employed by the bottom cover 9 and the pressurizing cylinder 72. When a T-shaped clamping jaw is aligned at an open groove of an L-shaped clamping seat, the bottom cover 9 is rotated, such that the clamping jaw is slid along a horizontal segment of an L-shaped track to a vertical locking segment. By this time, a radial pressing force is generated between a wedge-shaped oblique surface of the clamping jaw and an inner wall of the clamping seat, ensuring that the bottom cover 9 is attached to a bottom of the piston without a clearance. The snap-fit structure inhibits looseness by locking a frictional force caused by a wedge angle in mechanical vibration. When rotationally unlocked, the snap-fit structure is only rotated slightly and reversely. Without help of a tool, the gas guide channel is overhauled or cleaned. A sealing annular groove of a clamping surface cooperates with a bottom sealing ring of the piston, further ensuring dual-seal protection for a junction of the gas circuit, without affecting convenience in disassembly and assembly and system reliability.

Through cooperation between a stepped valve core 82 and a cylindrical valve body 81 of the relief valve 8, an intelligent pressure adjustment mechanism is formed. In response to a normal pressure in the sealed tank 4, the valve core forms an initial seal with a bottom of the valve body under its own weight, thereby preventing gas leakage. Once the pressure exceeds a preset threshold, the stepped valve core 82 pushed by the pressure slides upward along an inner wall of the valve body, and an annular relief channel is gradually formed between a stepped outer edge of the valve core and an inner wall of the valve body, such that the high-pressure gas is exhausted directionally through a top adjusting threaded hole. With a multi-stage variable diameter design of the stepped valve core 82, the openness of the channel is adjusted automatically and gradually with fluctuation of the pressure in pressure relief, preventing a sudden drop of the pressure due to sudden full opening of the channel, and realizing the gentle and controllable pressure relief. The adjusting threaded hole is internally provided with a thread, such that a limiting bolt can be screwed in the adjusting threaded hole. By changing a screw-in depth of the bolt, a maximum lift of the valve core is limited, thereby manually setting a critical pressure for the pressure relief. When dynamically balancing the pressure, the structure not only can realize adaptive fine adjustment based on a mechanical feedback for a gravity and a pressure difference of the valve core, but also can be limited mechanically to realize accurate overpressure protection. The dual function effectively maintains a stable pressure in the tank, preventing tear or structure damage of a sealing interface caused by an out-of-control pressure in extreme working conditions.

A bottom of the sealed tank 4 communicates with a water distribution tube 41. The water distribution tube 41 is configured to guide water at the bottom of the tank uniformly and stably for subsequent filtration. At least two filter cartridges 42 that are provided horizontally are connected to the water distribution tube 41. The filter cartridges 42 are horizontally and tidily distributed on a connecting path of the water distribution tube 41 to form an efficient and ordered filtering array. Each filter cartridge 42 has a distinct filtering function, and can perform deep purifying treatment on water flowing through it. When water flows to the filter cartridge 42 from the water distribution tube 41, various impurities, peculiar smells and possible harmful substances in the water are removed by a special filtering material in the filter cartridge 42, ensuring that the water meets safety and health standards. Upon completion of filtration, a water outlet of the filter cartridge 42 communicates with a water dispensing spout of the water dispenser through a water collecting tube. The water collecting tube is configured to collect clean water treated by the filter cartridge 42, and then convey it to the water dispensing spout of the water dispenser for use at any time.

It is to be noted that the bottom of the sealed tank 4 communicates with the water distribution tube 41, the water distribution tube 41 is connected to the filter cartridge 42, and the water outlet of the filter cartridge 42 communicates with the water dispensing spout of the water dispenser through the water collecting tube. In a possible embodiment, a plurality of filter cartridges are arranged horizontally side by side. The design in which the water distribution tube 41 is parallel connected to the plurality of filter cartridge 42 has many significant advantages. First of all, a water load can be balanced. In actual operation, the filter cartridges 42 may be different in filtering performance and water flow resistance. In case of no reasonable water distribution mechanism, parts of filter cartridges 42 are overloaded, while parts of filter cartridges 42 cannot work at a full capacity. With parallel connection to the water distribution tube 41, a water flow can be distributed reasonably according to an actual condition of each filter cartridge 42, ensuring that the filter cartridge 42 can work at an optimal state to improve filtration efficiency of the whole filtration system. Then, the modularized filter cartridges 42 greatly shorten a water route. In conventional design of the water dispenser, the water route is typically complicated and lengthy. This not only increases resistance to the water flow to affect a filtration rate, but also makes the water retain in the tube for a long time to increase the bacteria breeding risk of residual water. With the modularized filter cartridges 42, the water treated by the filter cartridges 42 can quickly enter the water collecting tube through a short water route, reducing unnecessary roundabout and retention, effectively lowering the likelihood of breeding bacteria, and ensuring safety and health of the drinking water. Besides, this design further facilitates branched maintenance. When some filter cartridge 42 has a problem or needs to be replaced, the corresponding filter cartridge 42 can be operated conveniently, without affecting normal operation of other filter cartridges 42. The modularized design greatly improves maintainability and management efficiency of the water dispenser, bringing more convenient and reliable use experience for the user.

Through a hidden detachable covering plate for an insertion port 11, a maintenance channel of the filter cartridge 42 and an appearance of the device are organically integrated. The covering plate is an embedded mounting structure flush with a surface of the outer housing 1, and is fixed by a magnetic fastener or a hidden fastener. In a closed state, the covering plate is seamlessly connected to a contour of the housing, making the overall shape of the water dispenser concise and beautiful. When the filter cartridge 42 is to be replaced, the filter cartridge can be detached by gently pressing an edge of the covering plate, thereby directly exposing an assembly position of the filter cartridge 42 in the sidewall insertion port 11. Without detaching other components of the outer housing 1, the old filter cartridge 42 can be pulled out horizontally and replaced by a new filter cartridge 42. A guide slide and a self-locking fastener are provided in the insertion port 11, ensuring that the filter cartridge 42 is accurately aligned and automatically locked at a preset position when inserted, and preventing leakage of the water route due to an installation error. With independent detachment of the covering plate, the filter cartridge 42 is maintained and operated locally, preventing problems that a bolt hole is worn and a sealing rubber strip is aged due to a fact that the outer housing 1 is opened frequently to replace the filter cartridge 42 in conventional design, and significantly prolonging a sealing service life of a main structure. Besides, as a protective barrier, the covering plate effectively prevents outside dust or liquid from entering the insertion port 11 in daily use, reduces an interface pollution risk of the filter cartridge 42, and forms a multi-layered protective system.

Through a ratio of a depth of the clamping groove 22 in the mounting wall edge 21 to a thickness of the mounting wall edge, a tradeoff between mechanical performance and sealing performance is achieved. The depth of the clamping groove 22 is defined as ⅓-½ of the thickness of the wall edge, such that after the clamping member 31 is embedded into the clamping groove, a sidewall of the clamping groove still keeps an enough structural strength, preventing cracking or deformation of the groove for stress concentration. Meanwhile, a stable supporting plane is formed on a contact surface between the bottom of the clamping groove 22 and the clamping member 31, which improves shear resistance of the snap-fit structure. An elastic sealing rubber strip at a bottom of the groove is squeezed by the clamping member 31 to cause radial expansion when the protective cover 3 is closed. This fully fills an assembly clearance between the clamping member 31 and the wall of the groove to form an annular liquid-sealed barrier, and effectively prevents the outside liquid from permeating into the bracket 2 along a gap of the groove. Through elastic restoration of the sealing rubber strip, a wearing clearance of a snap-fitted member in long-term use can further be compensated to maintain durability of the edge seal.

A portion of the main cover 5 threadedly connected the sealed tank 4 is provided with a sealing structure. Optionally, a double-layer sealing ring at the threaded connecting portion of the main cover 5 uses a differential sealing strategy to establish a composite protection system. When the main cover 5 is screwed into the sealed tank 4, a lower O-shaped ring comes into contact with an oblique surface of an opening of the tank, realizing a basic seal through radial compression and deformation. As the thread is screwed tightly, a tapered section of an upper wedge-shaped ring radially expands under an axial pressure to fill a microscopic cavity formed by a machining tolerance or a thread engagement clearance. When temperature fluctuation results in differential expansion of the metal tank and the plastic cover, the O-shaped ring absorbs a change of a radial size through elastic deformation, while the wedge-shaped ring compensates an axial displacement through slippage on the oblique surface. Through cooperation between the O-shaped ring and the wedge-shaped ring, damage of a thermal stress on the sealing interface is eliminated. Physical isolation of the double-layer structure further eliminates direct erosion of external vapor and pollutants on the O-shaped ring, reducing an overall aging rate of the sealing ring, and forming a gradient protection effect.

In conclusion, the well-sealed water dispenser provided by the present disclosure realizes the multi-seal barrier and structural stability through cooperation of a plurality of components. When the protective cover 3 is snap-fitted, the clamping member 31 on an inner wall of the protective cover and the clamping groove 22 of the bracket 2 form a first stage of locking, limiting radial displacement of the protective cover 3. Meanwhile, the main cover 5 is screwed into the opening of the sealed tank 4 through the thread, realizing axial pressing and sealing on the opening of the tank. The threaded connection and the snap-fit structure form dual locking, preventing looseness for vibration. The peripheral bump 61 of the limiting frame 6 is embedded into the limiting groove 23 of the bracket 2, which not only constricts peripheral rotation of the sealed tank 4, but also realizes rigid connection between the tank and the outer housing 1 through a clamping action, preventing the assembly clearance caused by expansion and contraction or impact of an external force. The protective cover 3 and the main cover 5 are designed in a split and penetrated manner. While ensuring independent sealing for the opening of the tank, this allows the snap-fitted action of the external protective cover and the threaded action of the internal main cover not to interfere with each other. This not only reduces the opening and closing resistance, but also disperses stress concentration through a hierarchical structure to prolong the service life of a sealing member. A stereoscopic limiting network formed among the components effectively inhibits vibration conduction, ensuring integrity of the sealing interface in long-term use. Therefore, the present disclosure effectively overcomes the shortcomings of the prior art and has the high industrial value.

It is understandable for a person of ordinary skill in the art that equivalent substitutions or changes can be made according to the technical solutions and inventive concepts of the present disclosure, and these substitutions or changes shall still fall within the protection scope of the claims of the present disclosure.

What is claimed is:

1. A well-sealed water dispenser, comprising:
an outer housing (1), wherein a bracket (2) is fixed at an upper opening of the outer housing (1) through a bolt, an inner wall of the bracket (2) extends upward to form a mounting wall edge (21), and a clamping groove (22) and a limiting groove (23) that are spaced apart are formed in the mounting wall edge (21);
a protective cover (3) provided with a clamping member (31) snap-fitted with the clamping groove (22);
a sealed tank (4) fixed in the outer housing (1), wherein a through hole is formed in a center of the protective cover (3), and a main cover (5) threadedly connected to an opening of the sealed tank (4) is provided at the through hole; and
a limiting frame (6) clamped between the bracket (2) and the sealed tank (4), wherein a peripheral bump (61) interlocked with the limiting groove (23) is provided on a sidewall of the limiting frame (6).

2. The well-sealed water dispenser according to claim 1, wherein a pressurizing hand pump (7) and a relief valve (8) are provided on the main cover (5); the pressurizing hand pump (7) comprises a pressurizing cylinder (72) with a one-way valve (71); a bottom cover (9) is snap-fitted to a bottom gas outlet of the pressurizing cylinder (72); and the bottom cover (9) is internally provided with a gas guide channel and connected to a bottom end of a gas guide tube (10) through the gas guide channel.

3. The well-sealed water dispenser according to claim 2, wherein a top end of the gas guide tube (10) extends above a liquid level in the sealed tank (4); and a tube body of the gas guide tube (10) is fixed by a hoop on an outer wall of a piston.

4. The well-sealed water dispenser according to claim 2, wherein a stepped valve seat is provided in a bottom chamber of the pressurizing cylinder (72); the one-way valve (71) is pressed into the valve seat through an interference fit; and a gas outlet is formed in a bottom of the valve seat.

5. The well-sealed water dispenser according to claim 2, wherein an L-shaped clamping seat is provided at an edge of the bottom cover (9); a T-shaped clamping jaw is correspondingly provided at a bottom of the pressurizing cylinder (72); and the L-shaped clamping seat is rotatably snap-fitted with the T-shaped clamping jaw.

6. The well-sealed water dispenser according to claim 2, wherein the relief valve (8) comprises a cylindrical valve body (81) and a stepped valve core (82); the cylindrical valve body (81) comprises a bottom provided with a gas inlet communicating with the sealed tank (4), and a top provided with an adjusting threaded hole; and the stepped valve core (82) is slidably provided in the cylindrical valve body.

7. The well-sealed water dispenser according to claim 1, wherein a bottom of the sealed tank (4) communicates with a water distribution tube (41); the water distribution tube (41) is connected to a filter cartridge (42); and a water outlet of the filter cartridge (42) communicates with a water dispensing spout of the water dispenser through a water collecting tube.

8. The well-sealed water dispenser according to claim 6, wherein an insertion port (11) for mounting the filter cartridge (42) is formed in a sidewall of the outer housing (1); and a detachable covering plate is provided at the insertion port (11).

9. The well-sealed water dispenser according to claim 1, wherein a depth of the clamping groove (22) in the mounting wall edge (21) is ⅓-½ of a thickness of the mounting wall edge;
and a sealing rubber strip is provided at a bottom of the clamping groove.

10. The well-sealed water dispenser according to claim 1, wherein a portion of the main cover (5) threadedly connected to the sealed tank (4) is provided with a sealing structure.
